(19) United States
(12) Patent Application Publication
(10) Pub. No.: US 2009/0196555 A1
(43) Pub. Date: Aug. 6, 2009

(54) FLEXIBLY BENDED BOOT FOR OPTICAL FIBER CONNECTOR

(75) Inventors: I. En Lin, Taipei (TW); Tomoyuki Mamiya, Marlboro, MA (US); Jeffery Gniadek, Marlboro, MA (US)

Correspondence Address: LOWE HAUPTMAN HAM & BERNER, LLP, 1700 DIAGONAL ROAD, SUITE 300, ALEXANDRIA, VA, 22314, US

(73) Assignees: PROTAI PHOTONIC CO. LTD, SINJHUANG CITY (TW); SENKO ADVANCED COMPONENTS, INC., MARLBORO, MA (US)

(21) Appl. No.: 12/421,020

(22) Filed: Apr. 9, 2009

(30) Foreign Application Priority Data
Nov. 12, 2008 (TW) 097148176

(51) Int. Cl. G02B 6/36

(52) U.S. Cl. 385/86

(57) ABSTRACT

A boot for an optical fiber connector according to the present invention is provided. The boot includes a hollow cylindrical body and a protrusion portion integrally formed on the hollow cylindrical body. In addition, a member with the property of plasticity is axially embedded in the protrusion portion so that the boot has the property of plasticity.

### CROSS REFERENCE TO RELATED APPLICATION

This application claims the priority benefit of Taiwan Patent Application Serial Number 097148176 filed Dec. 11, 2008, the full disclosure of which is incorporated herein by reference.

### BACKGROUND OF THE INVENTION

1. Field of the Invention

The invention relates to an optical fiber connector, and more particularly, to a boot for an optical fiber connector.

2. Description of the Related Art

The application of fiber optics to the telecommunication and data storage industries is expanding ever day. Fiber optics enables the high-speed transmission of communications and data. Connectors for optical fibers can be found in the back of instrumentation, telecommunication, routing, and switching cabinets. These cabinets accept a large number of fiber optical connectors. The optical fibers project away from the connector and tend to bend toward the ground due to the effect of gravity or the optical fibers are bent in a different direction due to an externally applied force. An optical signal passing through an optical fiber can experience a power loss if the bend radius of the optical fiber is too great. In order to prevent the optical fiber from being bent beyond a minimum bend radius, strain relief boots can be attached to the optical fiber in a region adjacent to the connector. The strain relief boot provides for a gentle, smooth, non-abrupt transition of the optical fiber from the connector to some other environment so as to maintain the optical signal at an acceptable power level.

Typically, strain relief boots have a straight, unbent shape when they are not subject to an externally applied force. Such a strain relief boot is disclosed in U.S. Pat. No. 5,781,681. FIG. 1 is taken from U.S. Pat. No. 5,781,681 showing a prior art connector 100. The prior art connector 100 includes the prior art optical fiber 110 which is surrounded, adjacent to the connector 100, by the prior art strain relief boot 120. When the prior art optical fiber 110 is subjected to a side load, such as the gravity, the strain relief boot 120 will bend. If the side load is too heavy, the boot 120 will bend greatly to cause a micro-bending loss of the fiber 110. Moreover, when a great number of fibers 110 are arranged in the above-mentioned cabinets, it is usually required to bundle these fiber 110 together. This will also cause the boot 120 to bend.

In order to solve the above problem, referring to FIG. 2, U.S. Pat. No. 6,695,486 discloses an angled optical fiber connector 200. However, the connector 200 is difficult to be angled.

In addition, referring to FIG. 3, U.S. Pat. No. 6,634,801 discloses an adjustable strain relief boot 300 for an optical fiber connector. The strain relief boot 300 includes a stationary portion 320 and a moving portion 330 slidably connected to the stationary portion 320. The bending angle of the boot 300 can be adjusted by moving the moving portion 330.

However, the bending angle of the boot 300 is adjusted through teeth. The teeth will cause the bending angle not to be adjusted arbitrarily. Furthermore, the mechanism of the moving portion 330 is a little bit complicated and the boot 300 can be angled only in a direction.

Accordingly, there exists a need to provide a flexibly bended boot to solve the above-mentioned problems.

### SUMMARY OF THE INVENTION

The present invention provides a flexibly bended boot for an optical fiber connector.

In one embodiment, the boot of the present invention includes an elastic hollow body which is cylindrical and defines an axial direction. A protrusion portion is integrally formed on the outer surface of the body along the axial direction. In addition, a member with the property of plasticity is axially embedded in the protrusion portion. The member can be integrally formed and is a metal wire, such as an iron wire

According to the present invention, the boot can be bent to a desired shape in subjection to an external force. When the boot is bent, the member will also be bent accordingly. The boot can still be kept in the desired shape even though when the external force vanishes. The boot can be bent to its original shape with an appropriate force.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 illustrates a conventional boot for an optical fiber connector.

FIG. 2 illustrates a conventional angled optical fiber connector.

FIG. 3 illustrates a conventional adjustable boot for an optical fiber connector.

FIG. 4 is an elevated perspective view of the flexibly bended boot for an optical fiber connector according to the present invention.

FIG. 5 is a cross-sectional view of the flexibly bended boot for an optical fiber connector according to the present invention.

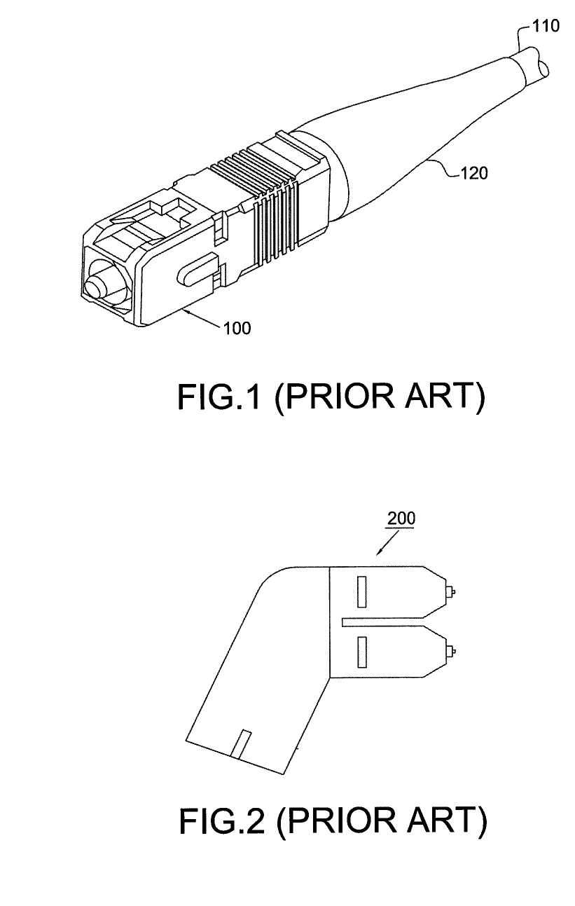

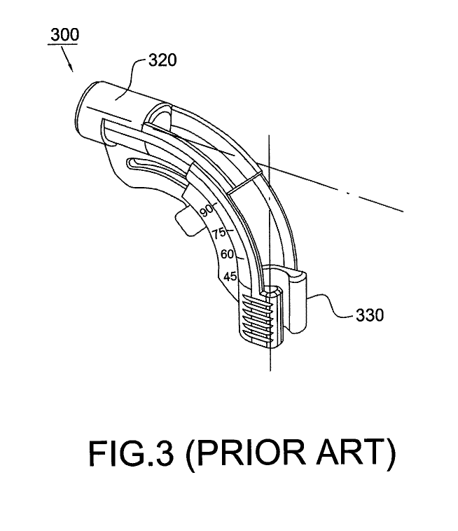

### DETAILED DESCRIPTION OF THE PREFERRED EMBODIMENT

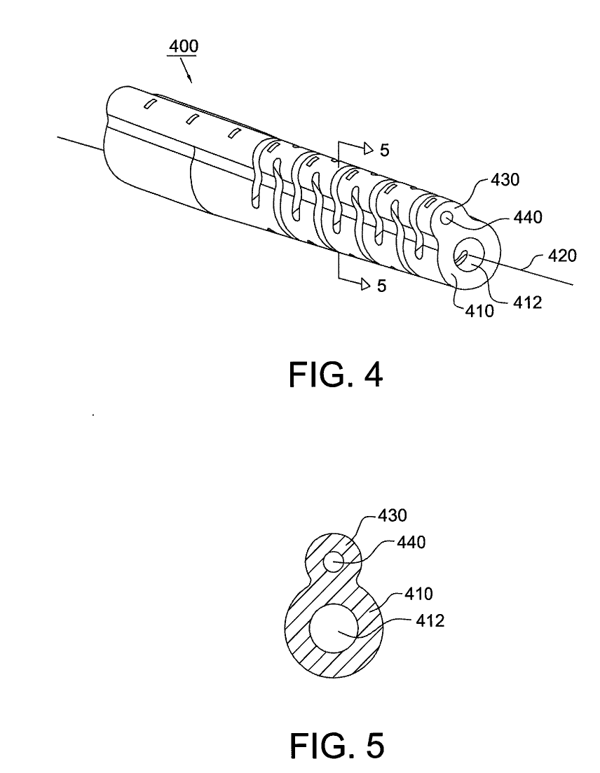

Referring to FIGS. 4 and 5, the flexibly bended boot 400 of the present invention is for an optical fiber connector. The boot 400 is adjacent to an optical fiber connector and surrounds an optical fiber (not shown in the figures). The boot 400 includes an elastic hollow body 410 which is cylindrical and defines an axial direction 420. A protrusion portion 430 is integrally formed on the outer surface of the body 410 along the axial direction 420. In addition, a member 440 with the property of plasticity is axially embedded in the protrusion portion 430. The member 440 can be integrally formed and is a metal wire, such as an iron wire

According to the present invention, the boot 400 can be bent to a desired shape in subjection to an external force. When the boot 400 is bent, the member 440 will also be bent accordingly. Since the member 440 has the property of plasticity, the boot 400 can still be kept in the desired shape even though when the external force vanishes. Similarly, the boot 400 can be bent to its original shape with an appropriate force. It is to be noted that the member 440 with the property of plasticity according to the present invention is one that can be bent to a desired shape in subjection to an external force and still be kept in the desired shape even though the external force vanishes. The member 440 can be bent to its original shape with an appropriate force.

It will be appreciated that the boot of the present invention can be used in any type of optical fiber connector, such as FC, SC or LC type connector.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A boot for an optical fiber connector, comprising:
a hollow cylindrical body defining an axial direction; and
a member with the property of plasticity, attached to the cylindrical body.

2. The boot as claimed in claim 1, further comprising:
a protrusion portion formed on the cylindrical body,
wherein the member is embedded in the protrusion portion.

3. The boot as claimed in claim 2, wherein the protrusion portion is integrally formed with the cylindrical body.

4. The boot as claimed in claim 1, wherein the member is along the axial direction.

5. The boot as claimed in claim 2, wherein the member is along the axial direction.

6. The boot as claimed in claim 1, wherein the member is integrally formed.

7. The boot as claimed in claim 2, wherein the member is integrally formed.

8. The boot as claimed in claim 1, wherein the member is a metal wire.

9. The boot as claimed in claim 5, wherein the member is a metal wire.

10. The boot as claimed in claim 1, wherein the member is an iron wire.

11. The boot as claimed in claim 5, wherein the member is an iron wire.
